(19) United States
(12) Patent Application Publication
(10) Pub. No.: US 2015/0104661 A1
(43) Pub. Date: Apr. 16, 2015

(54) MANUFACTURING METHOD OF ARTIFICIAL GRAPHITE SHEET AND PRODUCT THEREOF

(71) Applicant: CHE-YUAN WU, NEW TAIPEI CITY (TW)

(72) Inventor: CHE-YUAN WU, NEW TAIPEI CITY (TW)

(21) Appl. No.: 14/083,809

(22) Filed: Nov. 19, 2013

(30) Foreign Application Priority Data
Oct. 15, 2013 (TW) 102137213

(51) Int. Cl. B29D 7/01; B29C 43/00; B29C 43/24; C08J 5/18

(52) U.S. Cl. CPC B29D 7/01; C08J 5/18; B29C 43/003; B29C 43/24; C08J 2323/06; B29K 2103/04
USPC 428/523; 428/688; 524/1; 524/496; 524/586; 524/577; 523/468; 264/175

(57) ABSTRACT

A manufacturing method of artificial graphite sheet and a product thereof. The artificial graphite sheet manufactured by means of the manufacturing method can be rolled up to minimize the occupied space and facilitate transfer and delivery. The manufacturing method includes steps of: selecting graphite powder (granules) and polymer and mixing the graphite powder with polymer; heating, compounding and homogenizing the mixture to form a graphite (mixture) subassembly with a basic thickness; calendering the graphite subassembly to form a graphite (mixture) sheet assembly with a purposed thickness; thermostatically maturing the graphite sheet assembly and gradually cooling the graphite sheet assembly to room temperature to form a flexible sheet body; and rolling up the flexible sheet body into a roll form with a rolling apparatus. The manufacturing equipment and process of the artificial graphite sheet are simplified and the manufacturing time is shortened.

### BACKGROUND OF THE INVENTION

1. Field of the Invention

The present invention relates generally to a manufacturing method of artificial graphite sheet and a product thereof. The artificial graphite sheet manufactured by means of the manufacturing method has better ductility and malleability than the conventional artificial graphite sheet. Moreover, the artificial graphite sheet of the present invention can be rolled up to minimize the occupied space and facilitate transfer and delivery.

2. Description of the Related Art

It is known that artificial graphite substrate is applied to a heat source, a chip, an LED, etc. for conducting heat or dissipating heat. For example, a prior art discloses an artificial graphite heat dissipation substrate. In an environment of inert gas, a polyimide membrane is heated and carbonized into a graphite membrane, which is a laminated graphene collection with a thickness ranging from about 0.01 mm to 0.04 mm. Then, multiple layers of graphite membranes are thermally laminated in a laminating direction into the artificial graphite heat dissipation substrate with a thickness of about 50 mm.

In some other conventional techniques, chemical vapor deposition or high-temperature heating method is used to carbonize and graphitize a mixture of polymer solution and graphite to achieve a graphite membrane.

In the conventional manufacturing method of the artificial graphite substrate, multiple layers of graphite membranes are heated at about 1800° C.˜3000° C. and laminated to form the graphite substrate. The heating time is about 1.5 hours˜3 hours for completing the manufacturing of the graphite substrate. The manufacturing process is complicated and time-consuming. Moreover, for performing the high-temperature heating process, the cost for the equipment is increased.

Also, in general, the artificial graphite substrate is cast into a block for assembling with a heat source to conduct heat or dissipate heat. However, as known by those who are skilled in this field, in mechanical property, the conventional artificial graphite substrate is hard and crackly and is subject to breakage. Therefore, the conventional artificial graphite substrate cannot be freely flexed in accordance with the configuration of the heat source. As a result, the application range is limited. This is not what we expect.

It is therefore tried by the applicant to provide a manufacturing method of artificial graphite sheet and a product thereof. The artificial graphite sheet manufactured by means of the manufacturing method has better ductility and malleability than the conventional artificial graphite sheet. Accordingly, the artificial graphite sheet can be assembled and used in accordance with the configuration of the heat source. Moreover, the artificial graphite sheet can be bent to a greater extent and rolled up to minimize the occupied space and facilitate transfer and delivery. The conventional manufacturing method of the graphite substrate is complicated and time-consuming. Moreover, for performing the high-temperature heating process, the cost for the equipment is increased. In contrast, the manufacturing equipment and process of the artificial graphite sheet of the present invention are simplified and the manufacturing time is shortened.

### SUMMARY OF THE INVENTION

It is therefore a primary object of the present invention to provide a manufacturing method of artificial graphite sheet and a product thereof. The artificial graphite sheet manufactured by means of the manufacturing method can be bent to a greater extent and rolled up to minimize the occupied space and facilitate transfer and delivery.

To achieve the above and other objects, the manufacturing method of the artificial graphite sheet includes steps of: selecting graphite powder (granules) and polymer (such as linear low-density polyethylene) and mixing the graphite powder with polymer; heating, compounding and homogenizing the mixture to form a graphite (mixture) subassembly with a basic thickness; calendering the graphite subassembly to form a graphite (mixture) sheet assembly with a purposed thickness; thermostatically (or heat insulation) maturing the graphite sheet assembly and gradually cooling the graphite sheet assembly to room temperature to form a flexible sheet body; and rolling up the flexible sheet body into a roll form with a rolling apparatus. The conventional manufacturing method of the graphite substrate is complicated and time-consuming. Moreover, for performing the high-temperature heating process, the cost for the equipment is increased. In contrast, the manufacturing equipment and process of the artificial graphite sheet of the present invention are simplified and the manufacturing time is shortened.

In the above manufacturing method of the artificial graphite sheet, a (hot-wind) drier can be used to dry the graphite powder and the linear low-density polymer and remove the water thereof. An additive can be added into the graphite powder and the linear low-density polymer. A (double-threaded-rod) blending machine can be used to blend the mixture of the graphite powder and the polymer and the additive so as to form the graphite subassembly. The additive is selected from a group consisting of flexibilizer, modifier and the likes including polymer plastic material, epoxy, styrene copolymer, thermoplastic plastic or the like.

In the above manufacturing method of the artificial graphite sheet, before rolling up the graphite sheet assembly or the flexible sheet body, at least one surface of the graphite sheet assembly or the flexible sheet body is coated with an isolation material layer for avoiding adhesion of the roll of graphite sheet.

The artificial graphite sheet manufactured by means of the manufacturing method of the artificial graphite sheet is a flexible sheet body formed of the mixture of the graphite powder, the polymer and/or the additive. The artificial graphite sheet has better ductility and malleability than the conventional artificial graphite sheet and can be bent to a greater extent.

The present invention can be best understood through the following description and accompanying drawings, wherein:

### BRIEF DESCRIPTION OF THE DRAWINGS

FIG. 1 is a flow chart of the manufacturing method of the artificial graphite sheet of the present invention;

FIG. 2 is a perspective view of the artificial graphite sheet of the present invention; and

FIG. 3 is a perspective view showing that the artificial graphite sheet of the present invention is rolled up.

### DETAILED DESCRIPTION OF THE PREFERRED EMBODIMENTS

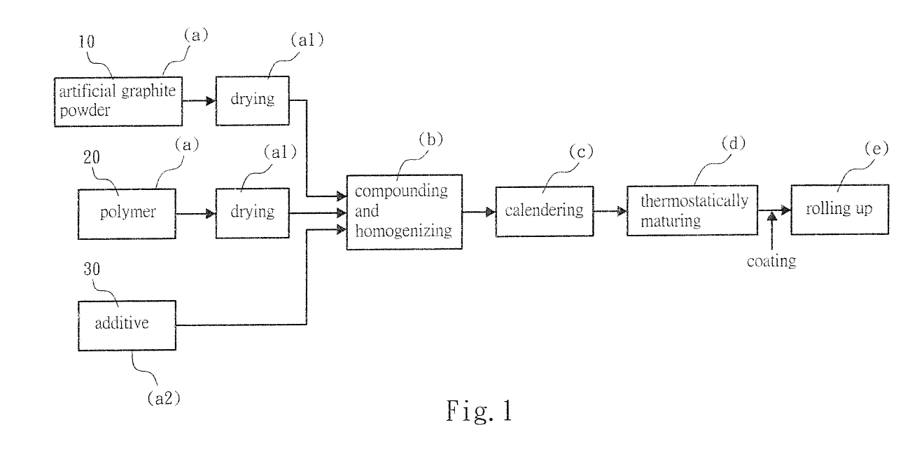

Please refer to FIG. 1. The manufacturing method of the artificial graphite sheet of the present invention includes a step of (a) selecting graphite powder (granules) 10 and a polymer 20 and mixing the graphite powder 10 with the polymer 20, the graphite powder 10 being such as artificial graphite powder with a granule diameter ranging from about 0.5 μm to 40 μm, the polymer 20 being selected from a group consisting of polymer plastic material (PP, PE, LDPE, POE, etc.), epoxy, styrene copolymer (SIS, SEBS, etc.), thermoplastic plastic (CPE, TPU, etc.) and the likes, preferably, the polymer 20 being selectively a (linear or nonlinear) low-density polyethylene, the low-density polyethylene helping in enhancing the flowability of the graphite powder 10 in the succeeding compounding and homogenization process, also, the low-density polyethylene helping in increasing the content of the added graphite powder 10 and enhancing the heat conduction efficiency of the artificial graphite sheet, the linearity and nonlinearity serving to modulate ductility and malleability of the product.

As shown in FIG. 1. In the manufacturing method of the artificial graphite sheet of the present invention, step (a) includes a sub-step (a1) of drying, a (hot-wind) drier being used to dry the graphite powder 10 and the polymer 20 and remove the water thereof. Step (a) further includes a sub-step (a2) of adding an additive 30 into the graphite powder 10 and the polymer 20, the additive 30 being selected from a group consisting of flexibilizer, modifier and the likes such as including polymer plastic material (PP, PE, LDPE, POE, etc.), epoxy, styrene copolymer (SIS, SEBS, etc.), thermoplastic plastic (CPE, TPU, etc.) or the like.

The manufacturing method of the artificial graphite sheet of the present invention further includes a step (b) of compounding and homogenizing, a double-threaded-rod blending machine being used to blend the mixture of the graphite powder 10 and the polymer 20 and/or the additive 30 so as to form a graphite (mixture) subassembly with a preliminary or basic thickness.

In this embodiment, in step (b) of compounding and homogenizing, the mixture is heated to enhance the operation effect.

As shown in FIG. 1, the manufacturing method of the artificial graphite sheet of the present invention further includes a step (c) of calendering, a calender being used to calender the graphite subassembly to form a graphite sheet assembly with a purposed thickness. The manufacturing method of the artificial graphite sheet of the present invention further includes a step (d) of thermostatic (or thermal insulation) maturing, the graphite sheet assembly being placed into a thermal insulation device for a period of time to mature or dry the graphite sheet assembly, then the graphite sheet assembly being gradually cooled to room temperature.

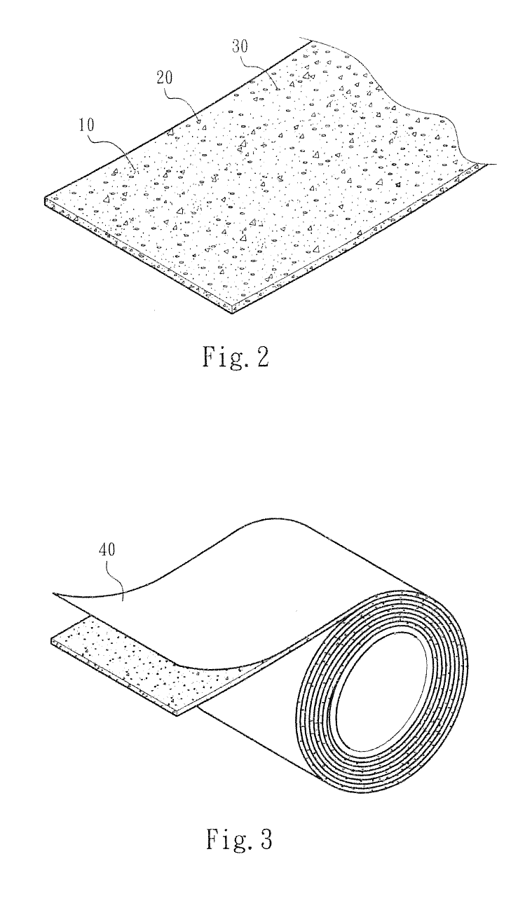

Please now refer to FIG. 2. The interior structure of the artificial graphite sheet (or graphite sheet assembly) of the present invention is composed of the graphite powder 10, the polymer 20 and/or the additive 30 by means of blending and homogenizing the mixture. Therefore, the artificial graphite sheet of the present invention has better mechanical properties such as flexibility, ductility and malleability than the conventional artificial graphite. The artificial graphite sheet of the present invention can be bent to a greater extent or calendered into a thin structure according to requirements.

In a preferred embodiment, the graphite sheet assembly can be rolled up into a roll form by means of a rolling apparatus. Accordingly, the manufacturing method of the artificial graphite sheet of the present invention further includes a step (e) of rolling as shown in FIG. 3.

In this embodiment, before step (e) of rolling, at least one surface of the graphite sheet assembly is coated with an isolation (material) layer 40 for avoiding adhesion of the roll of graphite sheet. The material of the isolation layer 40 can be PE or the like material.

The manufacturing method of the artificial graphite sheet and the product of the manufacturing method of the present invention are applicable to heat conduction or heat dissipation and have the following advantages:
1. In comparison with the conventional technique, the structure or composition of the artificial graphite sheet assembly of the present invention is specially designed and arranged. The artificial graphite sheet assembly of the present invention is composed of the graphite powder 10 and the polymer 20 by means of compounding and homogenizing the mixture so that the graphite sheet assembly of the present invention has better ductility and malleability than the conventional artificial graphite. In contrast, in the conventional method, the polyimide membrane is heated and carbonized into a graphite membrane. Then, multiple layers of graphite membranes are heated (at about 1800° C.˜3000° C.) and laminated to form the graphite substrate. The manufacturing process of the graphite substrate is complicated and time-consuming. Moreover, for performing the high-temperature heating process, the cost for the equipment is increased.
2. The graphite sheet assembly can be assembled and used in accordance with actual configuration of a heat source. The artificial graphite sheet of the present invention can be bent and collectively rolled to a greater extent so as to minimize the occupied space and facilitate transfer and delivery.

In conclusion, the manufacturing method of the artificial graphite sheet and the product of the manufacturing method of the present invention are different from and advantageous over the conventional techniques.

The above embodiments are only used to illustrate the present invention, not intended to limit the scope thereof. Many modifications of the above embodiments can be made without departing from the spirit of the present invention.

What is claimed is:

1. A manufacturing method of artificial graphite sheet, comprising steps of:
(a) selecting graphite powder and polymer and mixing the graphite powder with polymer;
(b) homogenizing the mixture of the graphite powder and the polymer to compound the mixture of the graphite powder and the polymer into a homogenized mixture, then the homogenized mixture being preliminarily formed into a graphite subassembly with a basic thickness; and
(c) calendering the graphite subassembly to form a graphite sheet assembly with a purposed thickness.

2. The manufacturing method of the artificial graphite sheet as claimed in claim 1, further comprising a step (d) of thermostatically maturing the graphite sheet assembly after step (c), then the graphite sheet assembly being cooled to room temperature.

3. The manufacturing method of the artificial graphite sheet as claimed in claim 1, wherein the graphite powder is artificial graphite powder with a granule diameter ranging from about 0.5 μm to 40 μm.

4. The manufacturing method of the artificial graphite sheet as claimed in claim 1, wherein the polymer is selected from a group consisting of polymer plastic material, epoxy, styrene copolymer and thermoplastic plastic.

5. The manufacturing method of the artificial graphite sheet as claimed in claim 1, wherein the polymer is linear low-density polyethylene.

6. The manufacturing method of the artificial graphite sheet as claimed in claim 1, wherein step (a) includes a sub-step (a1) of drying the graphite powder and the polymer and removing water thereof.

7. The manufacturing method of the artificial graphite sheet as claimed in claim 2, wherein step (a) includes a sub-step (a1) of respectively drying the graphite powder and the polymer and removing water thereof.

8. The manufacturing method of the artificial graphite sheet as claimed in claim 7, wherein in sub-step (a1), a drier is used to respectively dry the graphite powder and the polymer and remove the water thereof.

9. The manufacturing method of the artificial graphite sheet as claimed in claim 1, wherein step (a) further includes a sub-step (a2) of adding an additive into the graphite powder and the polymer, the additive being selected from a group consisting of flexibilizer and modifier.

10. The manufacturing method of the artificial graphite sheet as claimed in claim 2, wherein step (a) further includes a sub-step (a2) of adding an additive into the graphite powder and the polymer, the additive being selected from a group consisting of flexibilizer and modifier.

11. The manufacturing method of the artificial graphite sheet as claimed in claim 6, wherein step (a) further includes a sub-step (a2) of adding an additive into the graphite powder and the polymer, the additive being selected from a group consisting of flexibilizer and modifier.

12. The manufacturing method of the artificial graphite sheet as claimed in claim 7, wherein step (a) further includes a sub-step (a2) of adding an additive into the graphite powder and the polymer, the additive being selected from a group consisting of flexibilizer and modifier.

13. The manufacturing method of the artificial graphite sheet as claimed in claim 1, wherein step (a) further includes a sub-step (a2) of adding an additive into the graphite powder and the polymer, the additive being selected from a group consisting of polymer plastic material, epoxy, styrene copolymer, and thermoplastic plastic.

14. The manufacturing method of the artificial graphite sheet as claimed in claim 2, wherein step (a) further includes a sub-step (a2) of adding an additive into the graphite powder and the polymer, the additive being selected from a group consisting of polymer plastic material, epoxy, styrene copolymer, and thermoplastic plastic.

15. The manufacturing method of the artificial graphite sheet as claimed in claim 6, wherein step (a) further includes a sub-step (a2) of adding an additive into the graphite powder and the polymer, the additive being selected from a group consisting of polymer plastic material, epoxy, styrene copolymer, and thermoplastic plastic.

16. The manufacturing method of the artificial graphite sheet as claimed in claim 7, wherein step (a) further includes a sub-step (a2) of adding an additive into the graphite powder and the polymer, the additive being selected from a group consisting of polymer plastic material, epoxy, styrene copolymer, and thermoplastic plastic.

17. The manufacturing method of the artificial graphite sheet as claimed in claim 1, wherein in step (b) of homogenizing the mixture of the graphite powder and the polymer to compound the mixture, the mixture is heated to enhance the homogenization effect.

18. The manufacturing method of the artificial graphite sheet as claimed in claim 2, wherein in step (b) of homogenizing the mixture of the graphite powder and the polymer to compound the mixture, the mixture is heated to enhance the homogenization effect.

19. The manufacturing method of the artificial graphite sheet as claimed in claim 6, wherein in step (b) of homogenizing the mixture of the graphite powder and the polymer to compound the mixture, the mixture is heated to enhance the homogenization effect.

20. The manufacturing method of the artificial graphite sheet as claimed in claim 7, wherein in step (b) of homogenizing the mixture of the graphite powder and the polymer to compound the mixture, the mixture is heated to enhance the homogenization effect.

21. The manufacturing method of the artificial graphite sheet as claimed in claim 9, wherein in step (b) of homogenizing the mixture of the graphite powder and the polymer to compound the mixture, the mixture is heated to enhance the homogenization effect.

22. The manufacturing method of the artificial graphite sheet as claimed in claim 1, wherein in step (b), a double-threaded-rod blending machine is used to blend the mixture of the graphite powder and the polymer to form the graphite subassembly.

23. The manufacturing method of the artificial graphite sheet as claimed in claim 9, wherein in step (b), a blending machine is used to blend the mixture of the graphite powder, the polymer and the additive to form the graphite subassembly.

24. The manufacturing method of the artificial graphite sheet as claimed in claim 13, wherein in step (b), a blending machine is used to blend the mixture of the graphite powder, the polymer and the additive to form the graphite subassembly.

25. The manufacturing method of the artificial graphite sheet as claimed in claim 1, wherein in step (c) of calendering the graphite subassembly, a calender being used to calender the graphite subassembly to form the graphite sheet assembly.

26. The manufacturing method of the artificial graphite sheet as claimed in claim 2, wherein in step (c) of calendering the graphite subassembly, a calender being used to calender the graphite subassembly to form the graphite sheet assembly.

27. The manufacturing method of the artificial graphite sheet as claimed in claim 6, wherein in step (c) of calendering the graphite subassembly, a calender being used to calender the graphite subassembly to form the graphite sheet assembly.

28. The manufacturing method of the artificial graphite sheet as claimed in claim 7, wherein in step (c) of calendering the graphite subassembly, a calender being used to calender the graphite subassembly to form the graphite sheet assembly.

29. The manufacturing method of the artificial graphite sheet as claimed in claim 9, wherein in step (c) of calendering the graphite subassembly, a calender being used to calender the graphite subassembly to form the graphite sheet assembly.

30. The manufacturing method of the artificial graphite sheet as claimed in claim 13, wherein in step (c) of calendering the graphite subassembly, a calender being used to calender the graphite subassembly to form the graphite sheet assembly.

31. The manufacturing method of the artificial graphite sheet as claimed in claim 17, wherein in step (c) of calendering the graphite subassembly, a calender being used to calender the graphite subassembly to form the graphite sheet assembly.

32. The manufacturing method of the artificial graphite sheet as claimed in claim 2, wherein in step (d), the graphite sheet assembly is placed into a thermal insulation device to thermostatically mature the graphite sheet assembly.

33. The manufacturing method of the artificial graphite sheet as claimed in claim 9, wherein in step (d), the graphite sheet assembly is placed into a thermal insulation device to thermostatically mature the graphite sheet assembly.

34. The manufacturing method of the artificial graphite sheet as claimed in claim 13, wherein in step (d), the graphite sheet assembly is placed into a thermal insulation device to thermostatically mature the graphite sheet assembly.

35. The manufacturing method of the artificial graphite sheet as claimed in claim 17, wherein in step (d), the graphite sheet assembly is placed into a thermal insulation device to thermostatically mature the graphite sheet assembly.

36. The manufacturing method of the artificial graphite sheet as claimed in claim 2, further comprising a step (e) of rolling up the graphite sheet assembly into a roll form after step (d).

37. The manufacturing method of the artificial graphite sheet as claimed in claim 9, further comprising a step (e) of rolling up the graphite sheet assembly into a roll form after step (d).

38. The manufacturing method of the artificial graphite sheet as claimed in claim 13, further comprising a step (e) of rolling up the graphite sheet assembly into a roll form after step (d).

39. The manufacturing method of the artificial graphite sheet as claimed in claim 17, further comprising a step (e) of rolling up the graphite sheet assembly into a roll form after step (d).

40. The manufacturing method of the artificial graphite sheet as claimed in claim 36, wherein before step (e), at least one surface of the graphite sheet assembly is coated with an isolation layer.

41. The manufacturing method of the artificial graphite sheet as claimed in claim 37, wherein before step (e), at least one surface of the graphite sheet assembly is coated with an isolation layer.

42. The manufacturing method of the artificial graphite sheet as claimed in claim 38, wherein before step (e), at least one surface of the graphite sheet assembly is coated with an isolation layer.

43. The manufacturing method of the artificial graphite sheet as claimed in claim 39, wherein before step (e), at least one surface of the graphite sheet assembly is coated with an isolation layer.

44. An artificial graphite sheet manufactured by means of the manufacturing method of the artificial graphite sheet as claimed in claim 1, which is a flexible sheet body formed of the mixture of the graphite powder and the polymer by means of calendering.

45. The artificial graphite sheet as claimed in claim 44, wherein the graphite powder is artificial graphite powder with a granule diameter ranging from about 0.5 μm to 40 μm.

46. The artificial graphite sheet as claimed in claim 44, wherein the polymer is linear low-density polyethylene.

47. The artificial graphite sheet as claimed in claim 44, wherein an additive is added into the graphite powder and the polymer, the additive being selected from a group consisting of flexibilizer and modifier.

48. The artificial graphite sheet as claimed in claim 44, wherein an additive is added into the graphite powder and the polymer, the additive being selected from a group consisting of polymer plastic material, epoxy, styrene copolymer, and thermoplastic plastic.

49. The artificial graphite sheet as claimed in claim 44, wherein the artificial graphite sheet is a thin structure.

50. The artificial graphite sheet as claimed in claim 46, wherein the artificial graphite sheet is a thin structure.

51. The artificial graphite sheet as claimed in claim 44, wherein at least one surface of the artificial graphite sheet is coated with an isolation layer and the artificial graphite sheet is rolled up into a roll form.

52. The artificial graphite sheet as claimed in claim 46, wherein at least one surface of the artificial graphite sheet is coated with an isolation layer and the artificial graphite sheet is rolled up into a roll form.

53. The artificial graphite sheet as claimed in claim 49, wherein at least one surface of the artificial graphite sheet is coated with an isolation layer and the artificial graphite sheet is rolled up into a roll form.
